(19) United States
(12) Patent Application Publication
(10) Pub. No.: US 2025/0044456 A1
(43) Pub. Date: Feb. 6, 2025

(54) STORAGE SYSTEM AND METHOD FOR CELLULAR NETWORK SYSTEM

(71) Applicant: DISH WIRELESS L.L.C., Englewood, CO (US)

(72) Inventors: Mehdi ALASTI, Englewood, CO (US); Kazi BASHIR, Englewood, CO (US); Siddhartha CHENUMOLU, Englewood, CO (US)

(73) Assignee: DISH WIRELESS L.L.C., Englewood, CO (US)

(21) Appl. No.: 18/230,467

(22) Filed: Aug. 4, 2023

(51) Int. Cl. G01S 19/01; H04W 64/00

(52) U.S. Cl. CPC G01S 19/015; H04W 64/003

(57) ABSTRACT

A method for determining how long to store data in a data lake is disclosed. The travel data associated with a mobile device is received via cellular towers. The travel data is determined as to whether it meets a threshold associated with unusual behavior for a user of the mobile device. In response to determining that the travel data meeting or exceeding the unusual behavior threshold, the travel data is stored for long term storage which may be greater than a predetermined time length associated with short term storage.

### BACKGROUND

Demand for mobile bandwidth continues to grow as customers access new services and applications. To remain competitive, telecommunications companies must cost-effectively expand their network while also improving user experience.

Currently, cellular systems cannot store all data collected for long term purposes. Thus, when law enforcement may desire to access cellular phone records which may be essential in solving a crime, for example, these records are likely not available because they were either not stored at all or only stored for a short period of time.

### SUMMARY

Various embodiments provide solutions to store certain types of data for long term so that the data may be usable for entities, such as law enforcement.

According to an embodiment, disclosed is a method is disclosed for determining how long to store data in a data lake. Travel data associated with a mobile device is received via a series of clusters that each may comprise a distributed unit (DU) that communicates with a central unit (CU) and cellular towers. The travel data is determined as to whether it meets a threshold associated with unusual behavior for a user of the mobile device. In response to determining that the travel data meeting or exceeding the unusual behavior threshold, the travel data is stored for long term storage which may be greater than a predetermined time length associated with short term storage.

According to one embodiment, a cellular network system includes: a core network located on a public network and comprising a central unit (CU); a series of clusters that each comprise a distributed unit (DU) that communicates with the CU and cellular towers; and a storage management server. The storage management server is configured to: receive travel data associated with a mobile device via the series of clusters; determine whether the travel data meets a threshold associated with unusual behavior for a user of the mobile device; and in response to determining that the travel data meeting or exceeding the unusual behavior threshold, store the travel data for long term storage being greater than a predetermined time length associated with short term storage.

According to one embodiment, a storage management server includes processor that is configured to: receive travel data associated with a mobile device via the series of clusters; determine whether the travel data meets a threshold associated with unusual behavior for a user of the mobile device; and in response to determining that the travel data meeting or exceeding the unusual behavior threshold, store the travel data for long term storage being greater than a predetermined time length associated with short term storage.

### BRIEF DESCRIPTION OF THE DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIG. 1 illustrates a high level block diagram showing a 5G cellular network using vDUs and a vCU.

FIG. 2 illustrates a high level block diagram showing 5G cellular network with clusters.

FIG. 3 illustrates a block diagram of the system of FIG. 2 but further illustrating details of cluster configuration software, according to various embodiments.

FIG. 4 illustrates a system of a storing data in a cellular network system, according to various embodiments.

FIG. 5 illustrates a method of storing data in a cellular network, in according with some embodiments.

### DETAILED DESCRIPTION OF EMBODIMENTS

As mentioned above, various embodiments provide running containerized clusters (e.g., kubernetes clusters) along with a radio access network (“RAN”) to coordinate workloads in a cellular network, such as a 5G cellular network.

Broadly speaking, embodiments of the present invention provide methods, apparatuses and computer implemented systems for configuring a 5G cellular network using servers at cell sites, cellular towers and kubernetes clusters that stretch from a public network to a private network.

### Establishing a Cellular Network Using Containerized Clusters

First, the configuration using containerized application is discussed below. The containerized application can be any containerized application but is described herein as clusters for ease of illustration, but it should be understood that the present invention should not be limited to clusters and any containerized applications could instead be employed. In other words, the below description uses clusters and exemplary embodiments but the present invention should not be limited to clusters.

A cluster may be part of a set of nodes that run containerized applications. Containerizing applications is an operating system-level virtualization method used to deploy and run distributed applications without launching an entire virtual machine (VM) for each application.

A cluster configuration software is available at a cluster configuration server. This guides a user, such as system administrator, through a series of software modules for configuring hosts of a cluster by defining features and matching hosts with requirements of features so as to enable usage of the features in the cluster. The software automatically mines available hosts, matches host with features requirements, and selects the hosts based on host-feature compatibility. The selected hosts are configured with appropriate cluster settings defined in a configuration template to be part of the cluster. The resulting cluster configuration provides an optimal cluster of hosts that are all compatible with one another and allows usage of various features. Additional benefits can be realized based on the following detailed description.

The present application uses such containerized applications (e.g., clusters) to deploy a RAN so that the virtual distributed unit (“vDU”) (also referred to herein as the “DU”) of the RAN is located at one cluster and the virtual centralized unit (“vCU”) (also referred to herein as the “CU”) is located at a remote location from the vDU, according to some embodiments. This configuration allows for a more stable and flexible configuration for the RAN.

It should be understood that the present application is equally applicable to an O-RAN and thus, whenever the description herein refers to “RAN”, it should also be understood that the description equally works with an O-RAN.

With the above overview in mind, the following description sets forth numerous exemplary details in order to provide an understanding of at least some embodiments of the present invention. It will be apparent, however, to one skilled in the art that the present invention may be practiced without some or all of these details described herein and thus, should not be limited. Operations may be done in different orders, and may or may not include some of the processes described herein. Several exemplary embodiments of the invention will now be described in detail with reference to the accompanying drawings.

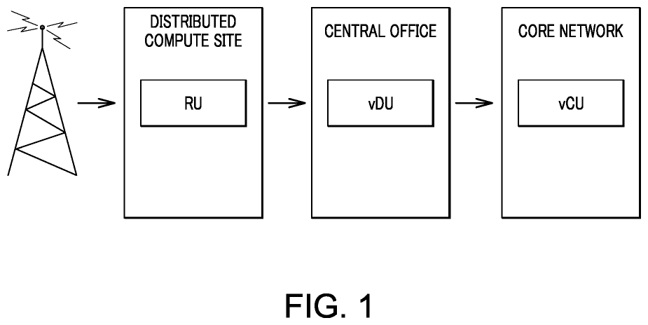

FIG. 1 illustrates a system that delivers full RAN functionality using network functions virtualization (NFV) infrastructure. In the embodiment shown in FIG. 1, the RAN includes a tower, radio unit (RU), a DU, a CU, and an element management system (EMS) (not shown). This approach decouples baseband functions from the underlying hardware and creates a software fabric. Within the solution architecture, virtualized baseband units (vBBU) process and dynamically allocate resources to remote RUs based on the current network needs. Baseband functions are split between CU, DUs and RUs that can be deployed in aggregation centers or in central offices (or data centers) using a distributed architecture, such as using clusters as discussed herein.

The virtualized CUs and DUs run as virtual network functions (VNFs) within the NFV infrastructure. The entire software stack that is needed is provided for NFV, including open source software. This software stack and distributed architecture increases interoperability, reliability, performance, manageability, and security across the NFV environment.

RAN standards may have deterministic, low-latency, and low-jitter signal processing, in some embodiments. These may be achieved using containerized applications (e.g., clusters) to control respective DUs, RUs and towers. Moreover, the RAN may support different network topologies, allowing the system to choose the location and connectivity of all network components. Thus, the system allowing various DUs on containerized applications (e.g., clusters) allows the network to pool resources across multiple cell sites, scale capacity based on conditions, and ease support and maintenance requirements.

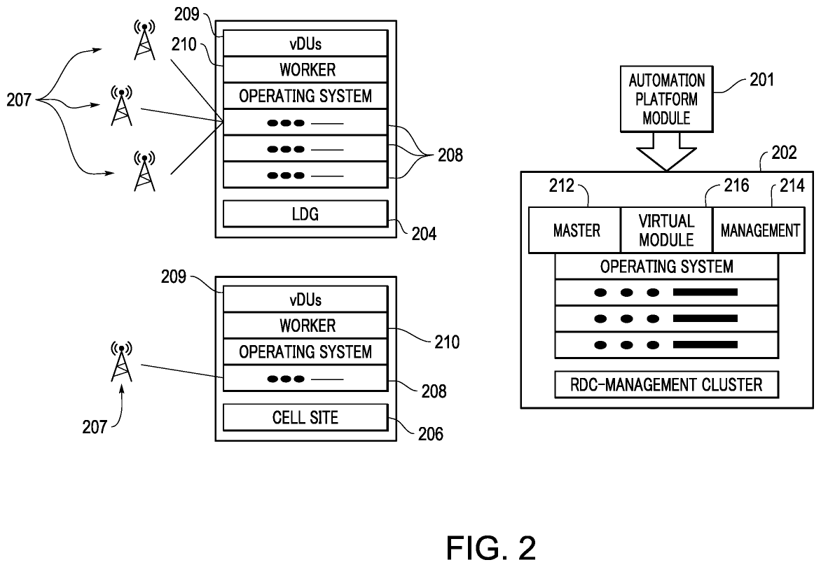

FIG. 2 illustrates an exemplary system used in constructing clusters that allows a network to control cell sites, in one embodiment of the invention. The system includes a cluster configuration server that can be used by a cell site to provide various containers for processing of various functions. Each of the cell sites are accessed via at least one cellular tower (and RRU) by the client devices, which may be any computing device which has cellular capabilities, such as a mobile phone, computer or other computing device.

As shown, the system includes an automation platform (AP) module 201, a remote data center (RDC) 202, one or more local data centers (LDC), and one or more cell sites 206.

The cell sites 206 provide cellular service to the client devices through the use of a vDU 209, server 208, and a tower 207. The server 208 at a cell site 206 controls the vDU 209 located at the cell site 206, which in turn controls communications from the tower 207. Each DU 209 is software to control the communications with the towers 207, RUs, and CU so that communications from client devices (not shown) can communicate from one tower 207 through the clusters to another cellular tower 207. In other words, the voice and data from a cellular mobile client device connects to the towers 207 and then goes through the DU 209 to transmit such voice and data to another DU 209 to output such voice and data to another tower 207 using workers 210 networked via a core network/CU.

The server(s) 208 on each individual cell site 206 or LDC 204 may not have enough computing power to run a control plane that supports the functions in the mobile telecommunications system to establish and maintain the user plane. As such, the control plane may be run in a location that is remote from the cell cites 206, such as the RDC 202.

The RDC 202 is the management cluster which manages the LDC 204 and a plurality of cell sites 206. As mentioned above, the control plane may be deployed in the RDC 202. The control plane maintains the logic and workloads in the cell sites 206 from the RDC 202 while each of the containerized applications (e.g., containers) is deployed at the cell sites 206. The control plane also monitors the workloads that are running properly and efficiently in the cell sites 206 and fixes any workload failures. If the control plane determines that a workload fails at the cell site 206, for example, the control plane redeploys the workload on the cell site 206.

The RDC 202 may include a master 212 (e.g., master), a management module 214 and a virtual (or virtualization) module 216. The master module 212 monitors and controls the workers 210 (also referred to herein as workers) and the applications running thereon, such as the DUs 209. If a DU 209 fails, the master module 212 recognizes this, and will redeploy the DU 209 automatically. In this regard, the clusters system has intelligence to maintain the configuration, architecture and stability of the applications running. Accordingly, the clusters system may be considered to be “self-healing”.

The management module 214 along with the Automation Platform 201 creates the clusters in the LDCs 204 and cell sites 206.

For each of the servers 209 in the LDC 204 and the cell sites 206, an operating system is loaded in order to run the workers 210. For example, such software could be ESKi and Photon OS. The DUs are also software, as mentioned above, that runs on the workers 210. In this regard, the software layers are the operating system, the workers 210, and then the DUs 209 as illustrated in FIG. 2.

The automation platform module 201 includes a GUI that allows a user to initiate clusters. The automation platform module 201 communicates with the management module 214 so that the management module 214 may create the clusters and a master module 212 for each cluster.

Prior to creating each of the clusters, the virtualization center 216 module creates a virtual machine (VM) so that the clusters can be created. VMs and containers are parts of the containerized applications (e.g., clusters) infrastructure of data centers and cell sites. VMs are emulations of particular computer systems that operate based on the functions and computer architecture of real or hypothetical computers. A VM is equipped with a full server hardware stack that has been virtualized. Thus, a VM includes virtualized network adapters, virtualized storage, a virtualized CPU, and a virtualized BIOS. Since VMs include a full hardware stack, each VM may include a complete operating system (OS) to function, and VM instantiation thus may need booting a full OS.

In addition to VMs, which provide abstraction at the physical hardware level (e.g., by virtualizing the entire server hardware stack), containers are created on top of the VMs. Containers provide abstraction at the OS level. In most container systems, the user space is also abstracted. Application presentation systems create a segmented user space for each instance of an application. Applications may be used, for example, to deploy an office suite to dozens or thousands of remote workers. In doing so, these applications create sandboxed user spaces on a server for each connected user. While each user shares the same operating system instance including kernel, network connection, and base file system, each instance of the office suite has a separate user space.

In any event, once the VMs and containers are created, the master modules 212 then create a DU 209 for each VM, as will be described later herein.

FIG. 2 also shows an LDC 204. In some embodiments, the LDC 204 is a data center that can support multiple servers and multiple towers for cellular communications. The LDC 204 is similar to the cell sites 206 except that each LDC 204 has multiple servers 208 corresponding to multiple towers 207 whereby each cell site 206 may only have a single server. Each server in the LDC 204 (as compared with the server in each cell site 206) may support multiple towers. The server 208 in the LDC 204 may be different from the server 208 in the cell site 206 because the servers 208 in the LDC 204 are larger in memory and processing power (number of cores, etc.) relative to the servers 208 in the individual cell sites 206. In this regard, each server 208 in the LDC 204 may run multiple DUs (e.g., 2 DUs), where each of these DUs independently operates a cell tower 207. Thus, multiple towers 207 can be operated through the LDCs 204 using multiple DUs using the clusters. The LDCs 204 may be placed in bigger metropolitan areas whereas individual cell sites 206 may be placed at smaller population areas.

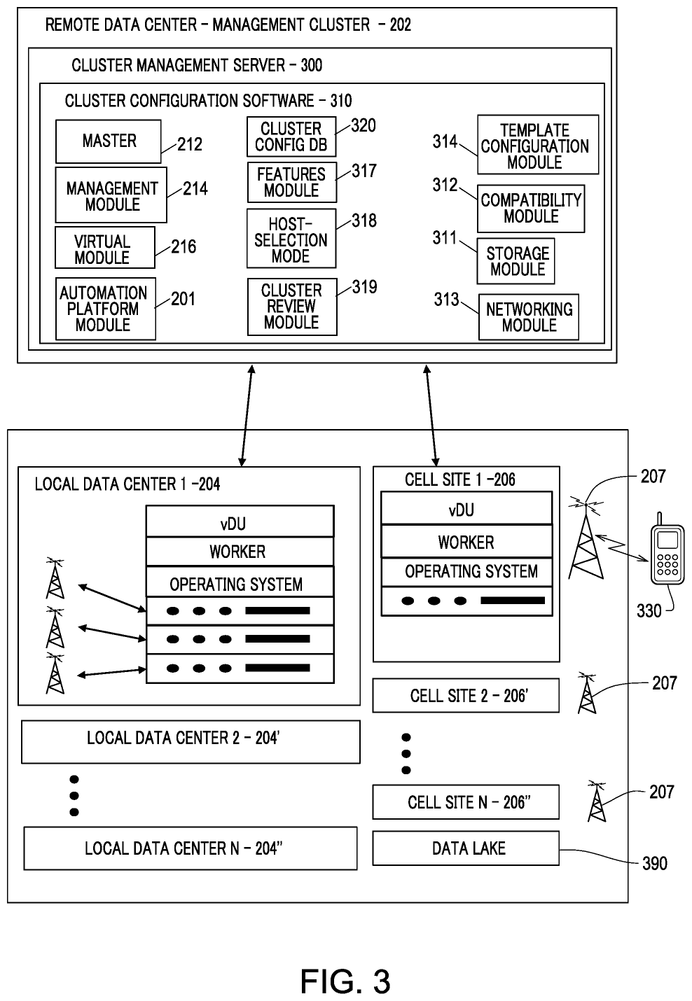

FIG. 3 illustrates a block diagram of the system of FIG. 2 but further illustrating details of cluster configuration software, according to various embodiments.

As illustrated, a cluster management server 300 is configured to run the cluster configuration software 310. The cluster configuration software 310 runs using computing resources of the cluster management server 300. The cluster management server 300 is configured to access a cluster configuration database 320. In one embodiment, the cluster configuration database 320 includes a host list with data related to a plurality of hosts including information associated with hosts, such as host capabilities. For instance, the host data may include list of hosts accessed and managed by the cluster management server 300, and for each host, a list of resources defining the respective host's capabilities. Alternately, the host data may include a list of every host in the entire virtual environment and the corresponding resources or may include only the hosts that are currently part of an existing cluster and the corresponding resources. In an alternate embodiment, the host list is maintained on a server that manages the entire virtual environment and is made available to the cluster management server 300.

In addition to the data related to hosts, the cluster configuration database 320 includes features list with data related to one or more features including a list of features and information associated with each of the features. The information related to the features include license information corresponding to each feature for which rights have been obtained for the hosts, and a list of requirements associated with each feature. The list of features may include, for example and without limitations, live migration, high availability, fault tolerance, distributed resource scheduling, etc. The list of requirements associated with each feature may include, for example, host name, networking and storage requirements. Information associated with features and hosts are obtained during installation procedure of respective components prior to receiving a request for forming a cluster.

Each host is associated with a local storage and is configured to support the corresponding containers running on the host. Thus, the host data may also include details of containers that are configured to be accessed and managed by each of the hosts. The cluster management server 300 is also configured to access one or more shared storage and one or more shared network.

The cluster configuration software 310 includes one or more modules to identify hosts and features and manage host-feature compatibility during cluster configuration. The configuration software 310 includes a compatibility module 312 that retrieves a host list and a features list from the configuration database 320 when a request for cluster construction is received from the client. The compatibility module 312 checks for host-feature compatibility by executing a compatibility analysis which matches the feature requirements in the features list with the hosts capabilities from the host list and determines if sufficient compatibility exists for the hosts in the host list with the advanced features in the features list to enable a cluster to be configured that can utilize the advanced features. Some of the compatibilities that may be matched include hardware, software and licenses.

It should be noted that the aforementioned list of compatibilities are exemplary and should not be construed to be limiting. For instance, for a particular advanced feature, such as fault tolerance, the compatibility module checks whether the hosts provide a compatible processor family, host operating system, hardware virtualization enabled in the BIOS, and so forth, and whether appropriate licenses have been obtained for operation of the same. Additionally, the compatibility module 312 checks to determine if networking and storage requirements for each host in the cluster configuration database 320 are compatible for the selected features or whether the networking and storage requirements may be configured to make them compatible for the selected features. In one embodiment, the compatibility module checks for basic network requirements. This might entail verifying each host's connection speed and the subnet to determine if each of the hosts has the desired speed connection and access to the right subnet to take advantage of the selected features. The networking and storage requirements are captured in the configuration database 320 during installation of networking and storage devices and are used for checking compatibility.

The compatibility module 312 identifies a set of hosts accessible to the management server 300 that either matches the requirements of the features or provides the best match and constructs a configuration template that defines the cluster configuration settings or profile that each host needs to conform in the configuration database 320. The configuration analysis provides a ranking for each of the identified hosts for the cluster. The analysis also presents a plurality of suggested adjustments to particular hosts so as to make the particular hosts more compatible with the requirements. The compatibility module 312 selects hosts that best match the features for the cluster. The cluster management server 300 uses the configuration settings in the configuration template to configure each of the hosts for the cluster. The configured cluster allows usage of the advanced features during operation and includes hosts that are most compatible with each other and with the selected advanced features.

In addition to the compatibility module 312, the configuration software 310 may include additional modules to aid in the management of the cluster including managing configuration settings within the configuration template, addition/deletion/customization of hosts and to fine-tune an already configured host so as to allow additional advanced features to be used in the cluster. Each of the modules is configured to interact with each other to exchange information during cluster construction. For instance, a template configuration module 314 may be used to construct a configuration template to which each host in a cluster may conform based on specific feature requirements for forming the cluster. The configuration template is forwarded to the compatibility module which uses the template during configuration of the hosts for the cluster. The host configuration template defines cluster settings and includes information related to network settings, storage settings and hardware configuration profile, such as processor type, number of network interface cards (NICs), etc. The cluster settings are determined by the feature requirements and are obtained from the Features list within the configuration database 320.

A configuration display module may be used to return information associated with the cluster configuration to the client for rendering and to provide options for a user to confirm, change or customize any of the presented cluster configuration information. In one embodiment, the cluster configuration information within the configuration template may be grouped in sections. Each section can be accessed to obtain further information regarding cluster configuration contained therein.

A features module 317 may be used for mining features for cluster construction. The features module 317 is configured to provide an interface to enable addition, deletion, and/or customization of one or more features for the cluster. The changes to the features are updated to the features list in the configuration database 320. A host-selection module 318 may be used for mining hosts for cluster configuration. The host-selection module 318 is configured to provide an interface to enable addition, deletion, and/or customization of one or more hosts. The host-selection module 318 is further configured to compare all the available hosts against the feature requirements, rank the hosts based on the level of matching and return the ranked list along with suggested adjustments to a cluster review module 319 for onward transmission to the client for rendering.

The cluster review module 319 may be used to present the user with a proposed configuration returned by the host-selection module 318 for approval or modification. The configuration can be fine-tuned through modifications in appropriate modules during guided configuration set-up which are captured and updated to the host list in either the configuration database 320 or the server. The suggested adjustments may include guided tutorial for particular hosts or particular features. In one embodiment, the ranked list is used in the selection of the most suitable hosts for cluster configuration. For instance, highly ranked hosts or hosts with specific features or hosts that can support specific applications may be selected for cluster configuration. In other embodiments, the hosts are chosen without any consideration for their respective ranks. Hosts can be added or deleted from the current cluster. In one embodiment, after addition or deletion, the hosts are dynamically re-ranked to obtain a new ranked list. The cluster review module 312 provides a tool to analyze various combinations of hosts before selecting the best hosts for the cluster.

A storage module 311 enables selection of storage requirements for the cluster based on the host connectivity and provides an interface for setting up the storage requirements. Shared storage may be needed in order to take advantage of the advanced features. As a result, one should determine what storage is shared by all hosts in the cluster and use only those storages in the cluster in order to take advantage of the advanced features. The selection options for storage include all the shared storage available to every host in the cluster. The storage interface provides default storage settings based on the host configuration template stored in the configuration database 320 which is, in turn, based on compatibility with prior settings of hosts, networks and advanced features and enables editing of a portion of the default storage settings to take advantage of the advanced features. In one embodiment, if a certain storage is available to only a selected number of hosts in the cluster, the storage module 311 will provide necessary user alerts in a user interface with tutorials on how to go about fixing the storage requirement for the configuration in order to take advantage of the advanced features. The storage module performs edits to the default storage settings based on suggested adjustments. Any updates to the storage settings including a list of selected storage devices available to all hosts of the cluster are stored in the configuration database 320 as primary storage for the cluster during cluster configuration.

A networking module 313 enables selection of network settings that is best suited for the features and provides an interface for setting up the network settings for the cluster. The networking module provides default network settings, including preconfigured virtual switches encompassing several networks, based on the host configuration template stored in the cluster configuration database, enables selecting/editing the default network settings to enter specific network settings that can be applied/transmitted to all hosts, and provides suggested adjustments with guided tutorials for each network options so a user can make informed decisions on the optimal network settings for the cluster to enable usage of the advanced features. The various features and options matching the cluster configuration requirements or selected during network setting configuration are stored in the configuration database and applied to the hosts so that the respective advanced features can be used in the cluster.

FIG. 3 also illustrates cell sites 206, 206′, 206″ that are configured to be clients of each cluster. Each cell site 206, 206′, 206″ is shown as includes a cellular tower 207 and a connection to each distributed unit (DU), similar to FIG. 2. Each DU may be a virtualized distributed unit 209, similar to FIG. 2, and each DU may run as virtual network functions (VNFs) within the an open source network functions virtualization (NFV) infrastructure.

Each of the cellular towers 207 is configured to communication via antenna communications to/from mobile devices 330, such as mobile phones, tablets, computing devices, IOT devices, and any other device with cellular communications capabilities. The communication is received via analog signals and then may be converted into digital signals which are then transmitted to the DU of a cluster associated with the cellular tower from which the communications were received. The DU then processes/transmits the data from signals as discussed herein.

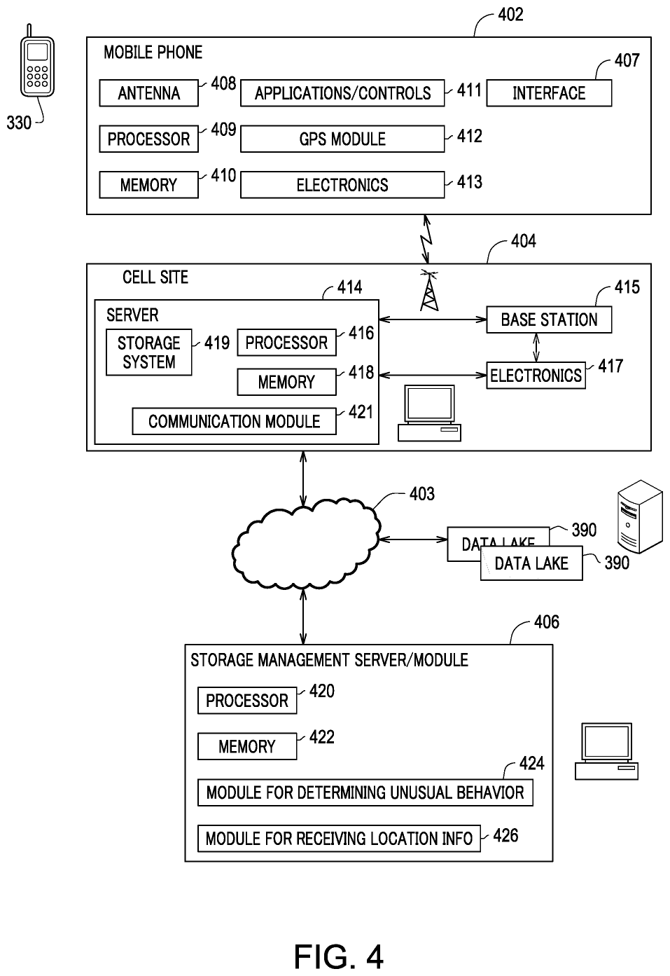

With the above overview of the various components of a system used in the cluster configuration, specific details of how each component is used in establishing and communicating through a cellular network using kubernetes clusters, as shown in FIG. 4. However, prior to discussing FIG. 4, the following background is provided.

Network operators of cellular systems, such as the one described herein, log several pieces of information for billing purposes, network optimization, and the like in data lakes. A data lake is a centralized repository that allows an entity to store structured and unstructured data at any scale. These entities can store the raw data as-is, without having to first structure the data, and run different types of analytics, and/or save data that has been processed.

In any event, the network operators keep these logs for a predefined short period of time and will remove/delete information from their data-lakes after the predefined short period of time (the “life-cycle of the information”) has expired.

However, some of these pieces of information can be requested later by certain third party entities, such as law enforcement agencies (“LEAs”). For example, after a terrorist attack in a geographical area, the LEAs may ask the network operators to provide them the list of people who were in that geographical area during a specific period of time

Unfortunately, the operators: (1) do not log every piece of information on their data-lakes; and/or (2) may not be able to provide expired information removed from the data-lake to the LEAs. This is quite unfortunate because certain data can be extremely useful for solving certain crimes or events or to help certain entities more effectively carry out their jobs/tasks.

By way of another example, for instance, if the LEAs find human remains in a sparse area belonging to months or even years back, but the network operators did not keep any information from that time on their logs, it is difficult for LEAs to help determine what happened. However, if this data was available, it could help the LEAs determine who was geographically in the area of interest, thereby identifying potential suspects and/or witnesses.

As discussed herein, the present disclosure presents solutions to these issues. First, analytic capabilities can enable the network operators to flag some unusual or suspicious subscriber behaviors. Unusual behavior, as used herein, refers to behavior that the user takes based on historical behavior of the user, based on historical behavior of one or more other users, or based on other predefined factors. Regardless, the unusual behavior are determined using analytic capabilities, Artificial intelligence and machine learning (AI/ML) engines may be employed to bring these analytic capabilities. Also, network functions, such as a 5G network data analytics function (NWDAF) enable the operators to detect some UEs unusual behaviors, and AI/ML APIs can be connected to a 5G network through NEF to detect some unusual and suspicious behaviors.

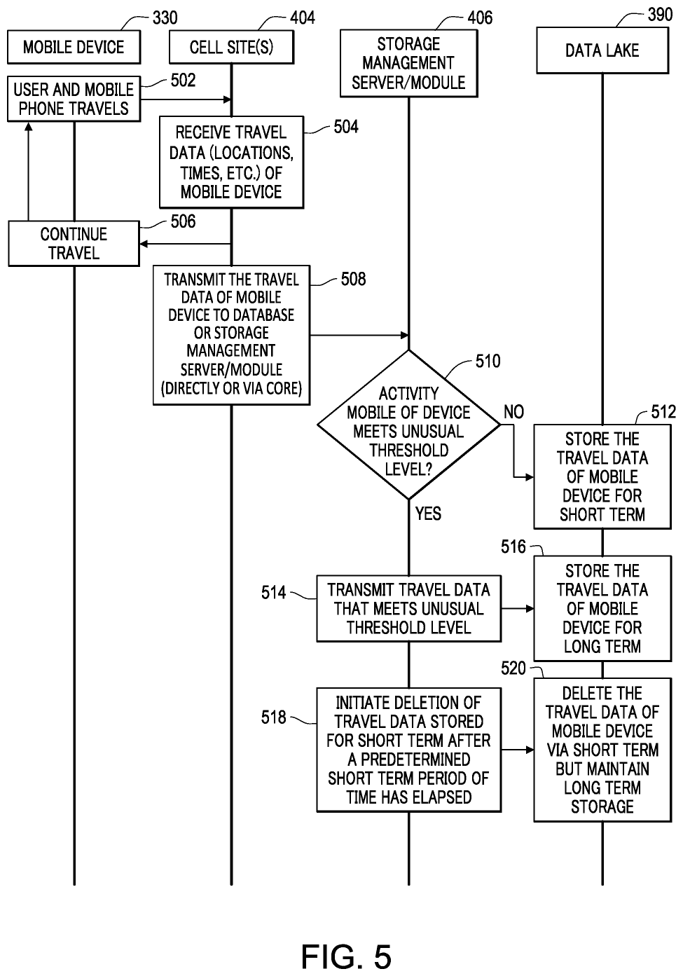

These solutions will be discussed more below with reference to FIGS. 4 and 5.

First, FIG. 4 illustrates an embodiment of a mobile device 330 (which could be a mobile cellular phone), a cell site 404, and a storage management server/module 406. The mobile device 330 includes an interface 407, an antenna 408, a processor 409, memory 410, applications/controls 411, a GPS module 412, and electronics 413. Each of these components is discussed in greater detail below.

The antenna 408 is configured to transmit and receive voice/text/data signals from a wireless connection on the network via at least one cell site 404. These signals are then processed by the processor 409 and software in the mobile device 330.

The processor 409 may be a hardware processor (e.g., CPU) that is configured to execute instructions stored in memory 410. The processor 409 is configured to interact with each of the applications/modules 411, 412, 413 and stored data and other software and/or data stored in the memory 410.

Any of the applications/modules 411, 412, 413 and other software modules or data may be stored in the memory 410. The memory 410 may be any type of temporary or persistent storage device capable of storing instructions and data. The memory 410 may be internal and/or external to the mobile device 330 and may include one or more storage devices. In one embodiment, the memory 410 is a non-transitory computer readable storage medium having a physical presence configured for long term and/or short term storage of data. For example, the memory 410 may be an internal hard drive, chip, or flash memory.

The applications/controls 411 is software with instructions that are executed by the processor 409 to perform functions of the mobile device 330. Examples of the applications/controls 411 may be to control the antenna of the phone to make calls, track the phones location, send/receive text messages or other data, and the like. The applications/controls 411 is configured to control one or more components of the mobile device 330 as desired by the user using the interface 407 (via a graphical user interface on the screen) of the mobile device 330.

The electronics 413 of the mobile device 330 are configured to work with the processor 409, memory 410 and antenna to send/receive signals to/from the network via the cell site 404, to send the mobile device's location to the cell site 404, or to perform other cellular operations. The electronics 413 may include a screen, logic to interconnect the hardware, and logic to process the signals to be sent and signals received.

The interface 407 includes not only GUIs for the user but a communications interface that works with the antenna 408 to communicate with the cell site 404, which includes the cell site server 414, base station 415, and electronics 417.

As mentioned above, the location of the mobile device 330 (or any other cellular wireless device) may be determined (using the GPS module 412 as a non-limiting example) and there are various methods and advantages to this. Indeed, the ability to routinely, reliably, and rapidly locate cellular wireless mobile phones has the potential to provide significant public benefit in public safety and convenience and in commercial and regulatory applications. A number of infrastructure-based, handset-based and network-based wireless location systems can be employed to locate the mobile phone while the mobile phone is active and transmitting/receiving signals.

Infrastructure-based location techniques for locating mobile phones 330 use information in use within the network (such as cell site 404) to generate an approximate geographic location. Infrastructure-based location techniques include CID (serving Cell-ID), CID-RTF (serving cell-ID plus radio time-of-flight time-based ranging), CIDTA (serving cell-ID plus time-based ranging), and Enhanced Cell-ID (ECID, a serving cell, time-based ranging and power difference of arrival hybrid). Signals that generate the network information that is the precursor to infrastructure-based location may be collected at the mobile device 330 or at the base station 415 of a cell site 404 and delivered to a mobile location server 414 which has databased knowledge of both the network topology and geographic topology of the clustered network described in FIGS. 1-3. This is completed for each cell site 404 of a plurality of cells sites within the clustered network.

Network-based location solutions use the specialized electronics 417, such as specialized receivers and/or passive monitors within, or overlaid on, the network to collect uplink (mobile phone-to-base station) signals, which are used to determine location and velocity of the mobile device 330. Overlay Network-based techniques include uplink Time-Difference-of-Arrival (TDOA), Angle-Of-Arrival (AOA), Multipath Analysis (RF fingerprinting), and signal strength measurement (SSM).

Mobile-device based location solutions use specialized electronics and/or software within the mobile device 330 to collect signaling. Location determination can take place in the device or information can be transmitted to a landside server which determines the location. Device-based location techniques include CID (serving Cell-ID), CID-RTF (serving cell-ID plus radio time-of-flight time-based ranging), CIDTA (serving cell-ID plus time-based ranging), Enhanced Cell-ID (ECID, a serving cell, time-based ranging and power difference of arrival hybrid), Advanced-Forward-Link-Trilateration (AFLT), Enhanced Observed Time Difference (E-OTD), Observed-Time-Difference-of-Arrival (OTDOA) and Global Navigation Satellite System (GNSS) positioning. An example of a GNSS system is the United States NavStar Global Positioning System (GPS).

Hybrids of the network-based and mobile device-based techniques can be used to generate improved quality of services including improved speed, accuracy, yield, and uniformity of location. A wireless location system determines geographic position and, in some cases, the speed and direction of travel of wireless devices. Wireless location systems use uplink (device-to-network) signals, downlink (network-to-device) signals, or non-communications network signals (fixed beacons, terrestrial broadcasts, and/or satellite broadcasts). Network-based location solutions use specialized receivers and/or passive monitors within, or overlaid on, the wireless communications network to collect signaling used to determine location. Network-based techniques include uplink Time-Difference-of-Arrival (TDOA), Angle-Of-Arrival (AOA), Multipath Analysis (RF fingerprinting), and signal strength measurement (SSM). Hybrids of the network-based techniques can be used to generate improved quality of services including speed, accuracy, yield, and uniformity of location.

These descriptions for infrastructure-based location determination systems enable robust and effective location-determination performance when adequate measurement data can be derived or are otherwise available.

Moreover, a Call Data Record (“CDR”, also known as Call Detail Record) is a data record which is generated at a telecommunication provider and is related to setup and termination of a call performed by a user through a mobile device and/or any form of data update performed by the mobile device. The CDR can adopt different formats depending on different telecom providers, and can include the location information of the mobile device Cell-ID (and of the user who holds the mobile device) and time information of the call. For example, the CDR can include information indicating an initiator of the call (e.g., an ID of the mobile device), information indicating a cell where the initiator initiates the call (e.g., an ID of the cell), information indicating a time at which the initiator initiates the call, information indicating a receiver of the call (e.g., an ID of a mobile device), information indicating the cell where the receiver is located (e.g., an ID of the cell), and a duration of the call. In many applications, the CDR is a data source to determine the location of people, which may include criminals or suspects, in efforts to determine evidence in the prosecution of crimes.

Additionally, the location information in the CDRs can be used for regulatory and commercial purposes. For regulatory use cases, after an incident in a geographical area, low enforcement agencies (LEAs) may ask the network operators the identity of all the subscribers in that area to determine suspects for a crime. For commercial use cases, the operator can use analytics for different purposes, i.e., location-based commercials, service optimization, etc.

Regardless of the application, the CDRs or other data may then be stored on a data lake 390 using the storage management server/module 406. The storage management server/module 406 may implement one or more steps of FIG. 5 and may be part of the cell site, the core network or a standalone server/module.

The storage management server/module 406, according to the present application, determines how long the data received from each (or a predefined set of) mobile device(s) will be stored as opposed to storing all data for a short period of time, where thereafter the data is then deleted. The storage management server/module 406 includes at least a processor 420, memory 422, a module for determining unusual behavior 424, and a module for receiving location information 426. Each of these components is discussed in greater detail below.

The processor 420 may be a hardware processor (e.g., CPU) that is configured to execute instructions stored in memory 422. The processor 420 is configured to interact with each of the modules 424, 426 and stored data and other software and/or data stored in the memory 422. For example, the processor 420 is configured to perform at least one or more or all of the steps presented herein, including those shown in FIG. 5.

Any of the applications/modules 424, 426 and other software modules or data may be stored in the memory 422. The memory 422 may be any type of temporary or persistent storage device capable of storing instructions and data. The memory 422 may be internal and/or external to the server 406 and may include one or more storage devices. In one embodiment, the memory 422 is a non-transitory computer readable storage medium having a physical presence configured for long term and/or short term storage of data. For example, the memory 410 may be an internal hard drive or flash memory.

The module for receiving location information 426 is configured for requesting and receiving, in response to the request, CDRs associated with a particular mobile phone or a series of mobile phones or all the mobile phones in a specific geographical area of interest. The module for receiving location information 426 will send a request to receive such CDRs and such request may include: identification of the mobile phone(s) 330, identification of the user of the mobile device 330, identification of a time period of interest being from a first time to a second time, etc. The module for receiving location information 426 is configured to send the request to the cell site 404 and/or the core network.

The module for determining unusual behavior 424 may be software with instructions that are executed by the processor 420 to perform functions of the FIG. 5. The analytics (provided by NWDAF or AI/ML engines) of the 5G network system (described here) detect unusual or suspicious activities of a subscriber to collect and log more pieces of information on the data-lake as well as to have a longer expiration time for this kind of information. The module for determining unusual behavior 424 may include AI/ML engines that determine whether the location and movement of the mobile device 330 based on a series of locations is unusual or not. The module for determining unusual behavior 424 collects a series of consecutive locations of the mobile device 330 to determine the movement of the mobile device 330 and thus, movement of the user. Such movement (using the series of locations) is then analyzed using AI/ML of the module for determining unusual behavior 424 to determine if the movement or behavior is considered unusual. Such determination is discussed in more detail with regard to FIG. 5.

As discussed above, the cell site 404 includes a server (such as mobile location server 414), a base station 415 and electronics 417. The base station 415 includes a tower to directly transmit/receive signals to/from the mobile device 330 and converts these signals into a format usable by the server 414. The processor 416 may be a hardware processor (e.g., CPU) that is configured to execute instructions stored in memory 418 and/or storage system 419. The processor 416 is configured to store data (e.g., location data, movement behavior, analysis, CDRs, etc.) stored in the memory 418 and execute software instructions. For example, the processor 206 is configured to perform at least one or more or all of the steps presented herein, including those shown in FIG. 5.

The memory 418 may be any type of temporary or persistent storage device capable of storing instructions and data. The memory 418 may be internal and/or external to the cell site 404 and may include one or more storage devices. In one embodiment, the memory 418 is a non-transitory computer readable storage medium having a physical presence configured for long term and/or short term storage of data. For example, the memory 418 may be an internal hard drive or flash memory.

The cell site 404 is configured to communicate with the location determination server 406 over a network 403, such as the Internet, a local area network (LAN), or a wide area network (WAN).

The mobile device 330 communicates with the cell site via a base station at a first time at a first location. While the mobile device 330 is performing such communications, CDRs are being created and each CDR includes a timestamp, where the mobile device 330 is located at each respective at the timestamp, the data sent or number called, the cell being used at the timestamp, identification of the mobile device 330 communicating with the cell site, and the like.

The cell site 404 then saves each CDR in memory at the cell site 404, as block 604. In other embodiments the CDRs are stored on the core network in a public cloud where the core network resides. Since the core network is implemented in the cloud, the saving of the CDRs also occurs in the cloud as well.

FIG. 5 illustrates a method of storing data in a cellular network, in according with some embodiments. As shown at block 502, the user travels with the mobile device 330. While traveling the mobile device may be communicating with the cellular towers. In this regard, the cell site 404 then receives mobile device's travel data including the location, the times associated with the corresponding locations, etc, as shown in block 504.

The process repeats from blocks 502 to 506 continually obtaining the mobile location and respective times of the locations of the mobile phone. This allows a series of locations and times to be determined in order to determine the movement behavior. The movement behavior relates to the locations that the user travels to but may also refer to the manner and times in which the user gets to a certain location. For example, the movement behavior may be a user being at a remote field at a specific time (e.g., 11 am), traveling at a high speed out of state, or visiting a home that has never been visited.

In block 508, the travel data of the mobile device 330 is transmitted from the cell site to the storage management server/module 406. The storage management server/module 406 then may immediately storage the data in the data lake 390. The storage management server/module 406 then make a determination, in block 510, as to whether the mobile device activity (location/time, movement behavior, etc.) meets unusual threshold level. As mentioned above, the unusual behavior is determined by the AI/ML of the module for determining unusual behavior 424. This may be based on certain predefined criteria, such as: visiting a location that the user does not visit more than a predefined number of times over a predefined time period, visiting a location at a particular unusual time (i.e., a time that most users do not visit the location), moving in a movement pattern that is not typical for the mobile device, and the like. Each of the criteria for the AI/ML is input and adds to a score. If the score exceeds a predetermined threshold, the AI/ML will then determine that the activity is unusual and return a match for unusual behavior. The AI/ML bases this determination over historical movement data for the mobile device that the user uses and/or on historical location/time data for the user. Such historical data gives the AI/ML baseline data for the user. However, it should be understood that instead of or in addition to historical data, the AI/ML may have predetermined unusual locations/times and movement or activity within such locations and/or at such times will trigger a score which may exceed the threshold level. For example, if a user is in a heavily wooded area at 2:30 am, this may trigger the score to exceed the threshold level.

Some probabilistic machine learning algorithms can be used: (1) LCM algorithm (Latent class model) for probabilistic classification can be used to check with what probability a member belongs to specific class (e.g., in the class of visitor of the area of interest); and (2) Bayesian classifiers can be used for filtration (e.g., spam filtration), classifying analysis (same as LCM), etc. Some other methods are: Logistic Regression, Hidden Markov model, Neural Networks, etc.

The storage management server/module 406 transmits to the data lake the travel data along with an optional short term storage indication in response to determining that the travel data does not meet the not unusual threshold level. Then, as shown in block 512, the travel data or mobile device activity is stored in the mobile device for short term storage. The short term storage may be a predefined time period, such as a day, a week, two weeks, a month, 3-4 months, a year or the like. Long term storage is defined as storage longer than the short term storage amount. Thus, if the short term storage is 3 months, the long term storage may be for 1 year, 1.5 years or 2 years. The long term storage may be any amount of time and should not be limited to a specific amount of time.

In block 514 and 516, the storage management server/module 406 transmits to the data lake the travel data along with an optional long term storage indication in response to determining that the travel data meets the unusual threshold level, and the data lake stores such travel data for long term storage.

The travel data is stored in the data lake with an expiration time limit. In block 518, after the travel data has been in the data lake for the time limit and thus, the time has expired, the travel data may be automatically deleted. For the short term data, the expiration is shorter than the expiration of the long term data in the data lake.

In one embodiment, the storage management server/module 406 then initiates deletion of the travel data stored for a short term after the predetermined short term period of time has elapsed, in block 518 and, in block 520, the data lake may receive instructions to delete the travel data where the predetermined short term period of time has elapsed.

It some embodiments, the intelligence can determine if a user is traveling on a road or path where the last location was and if the next known location is down the path after a certain distance, the model can determine that it is likely that the mobile phone was on the road or path while off, airplane mode, idle or inactive.

In this regard, the intelligence can use various factors in determining whether a user using a mobile phone traveling a certain path or was in the cell of interest, including historical locations or paths the user has taken, whether the likely path was on a road or path, determining points between the last known location and the next location received after a period of time after the last known location, directional data of the mobile phone, moving speeds, etc.

Once the intelligence determines the likely area the mobile device 330 was in during the period of time the mobile device 330 was idle, powered off, airplane mode, or inactive, the information is then transmitted to a third party (or computer) which will then process the data for a desired result.

Thus the invention herein can collect and log more pieces of information on the data-lake and have a longer expiration time for this kind of information. Since suspicious behaviors rarely happen, keeping this information is not very costly for the operators but they could be precious for the LEAs later. The analytics engine(s) can attach some different relevant information to make a more comprehensive information package in the case LEAs request for that in the future. This information is stored securely and privately somewhere in the data lake without anybody having access to them and will be retrieved and provided to the LEAs upon request.

Although specific embodiments were described herein, the scope of the invention is not limited to those specific embodiments. The scope of the invention is defined by the following claims and any equivalents therein.

As will be appreciated by one skilled in the art, aspects of the present disclosure may be embodied as a system, a method or a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a radio access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

What is claimed is:

1. A cellular network system comprising:
a radio access network (RAN) comprising a core network; and
a storage management server configured to:
receive travel data associated with a mobile device;
determine whether the travel data meets an unusual behavior threshold associated with unusual behavior for a user of the mobile device;
in response to determining that the travel data meets or exceeds the threshold, store the travel data for long term storage, the long term storage being greater than a predetermined time length associated with short term storage.

2. The system of claim 1, wherein the storage management server is further configured to in response to determining that the travel data being less than the unusual behavior threshold, store the travel data for short term storage which is less than the predetermined time length.

3. The system of claim 1, wherein the unusual behavior threshold is determined based on movement behavior that the user takes that is unusual for the user based on historical movement data of the user.

4. The system of claim 3, wherein the unusual behavior threshold is calculated based on a score, whereby the score is calculated by determining a number of instances the user has made the movement behavior in the past based on comparing the user's travel data with past movement behavior stored in the historical movement data of the user.

5. The system of claim 4, wherein the lower the number of instances that the movement behavior matches past movement behavior instances stored in the historical movement data, the higher the score is determined to be.

6. The system of claim 1, wherein the travel data comprises locations and times corresponding to respective locations of the mobile device.

7. The system of claim 1, wherein the RAN further comprises a central unit (CU); and a series of clusters that each comprise a distributed unit (DU) that communicates with the CU and cellular towers, wherein each respective cluster creates and then transmits the travel data from the DU of the cluster to the storage management server.

8. A storage management server comprising:
a processor configured to:
receive travel data associated with a mobile device via a series of clusters that each comprise a distributed unit (DU) that communicates with a central unit (CU) and cellular towers;
determine whether the travel data meets a threshold associated with unusual behavior for a user of the mobile device;
in response to determining that the travel data meets or exceeds the threshold associated with unusual behavior, store the travel data for long term storage, the long term storage being greater than a predetermined time length associated with short term storage.

9. The storage management server of claim 8, wherein the storage management server is further configured to in response to determining that the travel data being less than the unusual behavior threshold, store the travel data for short term storage which is less than the predetermined time length.

10. The storage management server of claim 8, wherein the unusual behavior threshold is determined based on movement behavior that the user takes that is unusual for the user based on historical movement data of the user.

11. The storage management server of claim 10, wherein the unusual behavior threshold is calculated based on a score, whereby the score is calculated by determining a number of instances the user has made the movement behavior in the past based on comparing the user's movement behavior with past movement behavior stored in the historical movement data of the user.

12. The storage management server of claim 11, wherein the lower the number of instances that the movement behavior matches past movement behavior instances stored in the historical movement data, the higher the score is determined to be.

13. The storage management server of claim 8, wherein the travel data comprises locations and times corresponding to respective locations of the mobile device.

14. The storage management server of claim 8, wherein each respective cluster creates and then transmits the travel data from the DU of the cluster to the storage management server.

15. A method comprising:
receive travel data associated with a mobile device via a series of clusters that each comprise a distributed unit (DU) that communicates with a central unit (CU) and cellular towers;
determine whether the travel data meets a threshold associated with unusual behavior for a user of the mobile device;
in response to determining that the travel data meets or exceeds the threshold associated with unusual behavior, store the travel data for long term storage, the long term storage being greater than a predetermined time length associated with short term storage.

16. The method of claim 15, further comprising: in response to determining that the travel data being less than the unusual behavior threshold, store the travel data for short term storage which is less than the predetermined time length.

17. The method of claim 15, wherein the unusual behavior threshold is determined based on movement behavior that the user takes that is unusual for the user based on historical movement data of the user.

18. The method of claim 17, further comprising calculating the unusual behavior threshold based on a score by determining a number of instances the user has made the movement behavior in the past based on comparing the user's movement behavior with past movement behavior stored in the historical movement data of the user.

19. The method of claim 18, wherein the lower the number of instances that the movement behavior matches past movement behavior instances stored in the historical movement data, the higher the score is determined to be.

20. The method of claim 1, wherein the travel data comprises locations and times corresponding to respective locations of the mobile device.
